(19) United States
(12) Patent Application Publication
(10) Pub. No.: US 2019/0094444 A1
(43) Pub. Date: Mar. 28, 2019

(54) OPTICAL COUPLING OF WAVEGUIDE AND DLP LIGHT ENGINE

(71) Applicant: Flex Ltd., Singapore (SG)

(72) Inventors: Jiayin Ma, Palo Alto, CA (US); Pinchuan Li, Shanghai (CN); Yuqing Han, Shanghai (CN); LianFang Zhao, Kunshan City (CN)

(21) Appl. No.: 16/145,440

(22) Filed: Sep. 28, 2018

(30) Foreign Application Priority Data
Sep. 28, 2017 (CN) 201710897767.2

(51) Int. Cl. F21V 8/00; G02B 27/01

(52) U.S. Cl. CPC G02B 6/0031; G02B 2027/0134; G02B 6/003; G02B 27/0172

(57) ABSTRACT

Devices and systems of a near eye system are provided. In particular, the near eye system may include a digital light processor, a first prism optically coupled to the digital light processor, a lens assembly optically coupled to the first prism, a second prism optically coupled to the lens assembly, and a waveguide configured to direct optical energy received from the second prism into an eye of a user.

### CROSS REFERENCE TO RELATED APPLICATION

The present application claims the benefits of Chinese Patent Application No. 2017/10897767.2 filed Sep. 29, 2017 entitled “OPTICAL COUPLING OF WAVEGUIDE AND DLP LIGHT ENGINE”, which is incorporated herein by this reference in its entirety.

### FIELD

The present disclosure is generally directed to an optical system coupling one or more waveguides to a DLP projection engine.

### BACKGROUND

In an augmented reality product, a near eye system generates an image utilizing equipment that provides the image to an eye of an observer and/or user. The generated image appears to be in front of the user; thus, such equipment utilized to generate the image should not block a view of the real world. Accordingly, the near eye equipment may be similar to a pair of glasses that are worn on a head of the user and provided in front of the user's eyes. To enhance a viewing experience, the weight of the equipment should be as light as possible. Moreover, to ensure that the image is visible and that the image quality is acceptable, the near eye equipment should provide an acceptable level of brightness. In addition, the field of view is also an important parameter; the larger the field of view, the better the image will be when mixed with the real world in an augmented reality system.

### BRIEF DESCRIPTION OF THE DRAWINGS

FIG. 1 depicts a first diagram of a near eye system in accordance with embodiments of the present disclosure;

FIG. 2 depicts a second diagram of a near eye system in accordance with embodiments of the present disclosure;

FIG. 3A depicts a perspective view of the near eye system of FIG. 1;

FIG. 3B depicts a perspective view of the near eye system of FIG. 2;

FIG. 4 depicts a third diagram of a near eye system in accordance with embodiments of the present disclosure;

FIG. 5 depicts a fourth diagram of a near eye system in accordance with embodiments of the present disclosure:

FIG. 6 depicts a fifth diagram of a near eye system in accordance with embodiments of the present disclosure;

FIG. 7A depicts a perspective view of a near eye system in accordance with embodiments of the present disclosure;

FIG. 7B depicts a perspective view of a near eye system in accordance with embodiments of the present disclosure; and

FIG. 8 depicts another perspective view of a near eye system in accordance with embodiments of the present disclosure.

FIG. 9 is a flow diagram of a method of assembling a near eye system in accordance with embodiments of the present disclosure.

FIG. 10 is a flow diagram of a method of assembling a near eye system in accordance with embodiments of the present disclosure.

### DETAILED DESCRIPTION

It is with respect to the above issues and other problems that the embodiments presented herein were contemplated. In general, embodiments of the present disclosure provide devices and systems by which optical energy from a digital light processor is incorporated into, or otherwise coupled, to a waveguide. At least one aspect of the present disclosure includes a near eye system, including a digital light processor, a first prism optically coupled to the digital light processor, a lens assembly optically coupled to the first prism, a second prism optically coupled to the lens assembly, and a waveguide configured to direct optical energy received from the second prism into an eye of a user.

Embodiments of the present disclosure include where the second prism is optically coupled with the waveguide on a same side as the eye of the user.

Embodiments of the present disclosure include where the second prism is optically coupled with the waveguide on an opposite side from the eye of the user.

Embodiments of the present disclosure include where the digital light processor is located on a side of the near eye system that is away from the user.

Embodiments of the present disclosure include where a heatsink of the digital light processor is located on a side that is away from the user.

Embodiments of the present disclosure include where the digital light processor is located at an angle that is greater than or equal to 106 degrees from the waveguide.

Embodiments of the present disclosure include where a second lens assembly, wherein the second lens assembly is optically coupled between the second prism and the waveguide.

Embodiments of the present disclosure include where a distance between the second prism and the waveguide is less than 4 millimeters.

Embodiments of the present disclosure include a second near eye system.

Embodiments of the present disclosure provide a digital light processor; a first lens assembly; a second lens assembly; a first prism optically coupled to the digital light processor, the first lens assembly, and the second lens assembly; a second prism optically coupled to the first lens assembly; a third prim optically coupled to the second lens assembly; a first waveguide configured to direct optical energy received from the second prism into a first eye of a user; and a second waveguide configured to direct optical energy received from the third prism into a second eye of the user.

Embodiments of the present disclosure include where the second prim is optically coupled with the first waveguide on a first same side as the first eye of the user and wherein the third prim is optically coupled with the second waveguide on a second same side as the second eye of the user.

Embodiments of the present disclosure include where the second prim is optically coupled with the first waveguide on a first opposite side from the first eye of the user and wherein the third prim is optically coupled with the second waveguide on a second opposite side from the second eye of the user.

Embodiments of the present disclosure include where the digital light processor and/or a first heatsink of the digital light processor are located on a first side of the near eye system that faces is away from the user.

Embodiments of the present disclosure include where a first distance between the second prism and the first waveguide is less than 4 millimeters and wherein a second distance between the third prism and the second waveguide is less than 4 millimeters.

Embodiments of the present disclosure provide a near eye system, comprising: a first prism; a first digital light processor; a second digital light processor, wherein the first digital light processor and the second light processor are optically coupled to the first prism; a first lens assembly; a second lens assembly, wherein the first prism optically coupled to the first lens assembly and the second lens assembly; a second prism optically coupled to the first lens assembly; a third prim optically coupled to the second lens assembly; a first waveguide configured to direct optical energy received from the second prism into a first eye of a user; and a second waveguide configured to direct optical energy received from the third prism into a second eye of the user.

Embodiments of the present disclosure include the first digital light processor and the second light processor are optically coupled to the first prism on opposite sides of the first prism.

Embodiments of the present disclosure include the second prim is optically coupled with the first waveguide on a first same side as the first eye of the user and wherein the third prim is optically coupled with the second waveguide on a second same side as the second eye of the user.

Embodiments of the present disclosure include where the second prim is optically coupled with the first waveguide on a first opposite side of the first eye of the user and wherein the third prim is optically coupled with the second waveguide on a second opposite side from the second eye of the user.

Embodiments of the present disclosure include a heatsink of the first and/or second digital light processor is located on a side of the near eye system that faces is away from the user.

Embodiments of the present disclosure include where a first distance between the second prism and the first waveguide is less than 4 millimeters and wherein a second distance between the third prism and the second waveguide is less than 4 millimeters

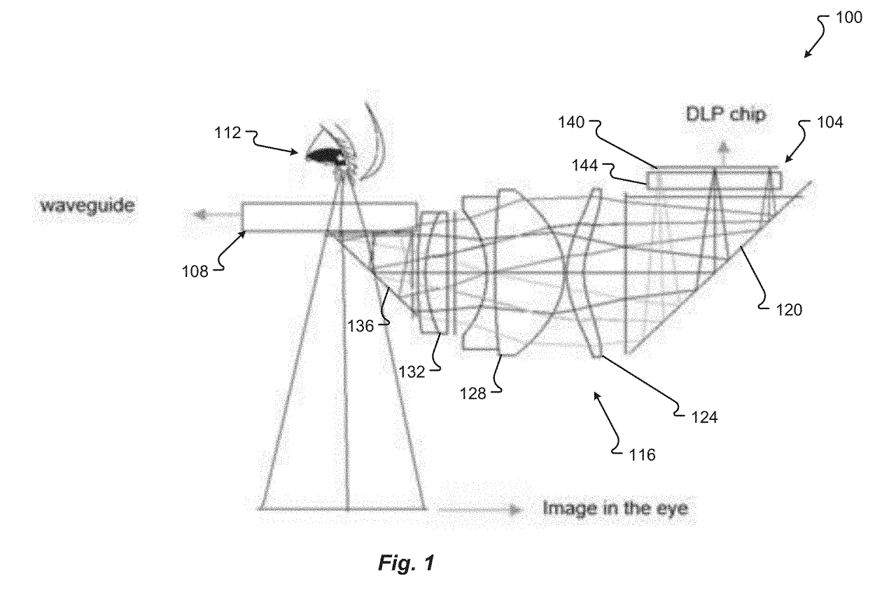

FIG. 1 depicts a first diagram of a near eye system 100 in accordance with embodiments of the present disclosure. The near eye system 100 may direct optical energy from a DLP light engine 104 (or other light source) to a waveguide 108 in order to couple the optical energy from the DLP light engine 104 into an eye of a user 112. The near eye system 100 may further include a first prism 120, a lens assembly 116, and a second prism 136 to guide or otherwise couple optical energy from the DLP light engine 104 to the waveguide 108. Thus, the DLP light engine 104 may include a light source 140 providing optical energy to a digital light processor 144. The DLP light engine 104 is generally based on optical micro-electro-mechanical technology that uses a digital micro-mirror device to direct, reflect, and/or guide light into a projected image. Thus, an image may be created by microscopically small mirrors laid out in a matrix on a semiconductor chip, known as a Digital Micro-mirror Device (DMD), where each mirror represents one or more pixels in the projected image. The digital light processor 144 may include one or more DMDs as well as one or more controllers for controlling the one or more DMDs. The light source 140 may include one or more LED light sources, laser-based light sources, and/or other light sources. For example, one or more LEDs of a specific color may be utilized in the projection of an image.

The prism/reflector 120 may receive optical energy from the DLP light engine 104 and direct, guide, and/or reflect the optical energy to the prism/reflector 136 via the lens assembly 116. That is, the lens assembly 116 may include a first lens element 124, a second lens element 128, and a third lens element 132 to adjust one or more parameters of a projected image. For example, the lens assembly 116 may adjust a size of a projected image with little to no image distortion. As one example, the first lens element 124 may collect light, the second lens element 128 may reshape light, and the third lens element 132 may converge light. Moreover, the lens assembly 116 may include more or fewer lens elements (e.g., 1 to N lens elements). In accordance with at least one embodiment of the present disclosure, one or more components of the prism/reflector 120, lens assembly 116, and the prism/reflector 136 may each be adjustable and/or moveable. Alternatively, or in addition, one or more components of the prism/reflector 120, lens assembly 116, and the prism/reflector 136 may be fixed during a manufacturing process. For example, the prism/reflector 120 and the lens assembly 116 may be fixed during manufacturing while the prism/reflector 136 may be adjustable. Thus, the near eye system 100 may incorporate design characteristics that aid in a manufacturing process.

The prism/reflector 136 couples the optical energy of the DLP light engine 104 into the waveguide 108. The waveguide 108 is a physical structure that guides optical energy toward a pupil of an eye 112 of a user. Thus, the optical energy may enter the waveguide 108 at an angle that is generally perpendicular to a transmissive surface, propagate horizontally through the waveguide 108, and exit at an angle that is generally perpendicular to the transmissive surface toward an eye 112 of a user. As depicted in FIG. 1, the waveguide 108 is positioned between the eye 112 of the user and the prism/reflector 136. That is, the prism/reflector 136 may be located at a surface of the waveguide 108 that is opposite to a surface in which optical energy exits the waveguide 108 in a direction toward an eye 112 of a user. Thus the entry and exit surfaces of the waveguide 108 may be opposite to one another.

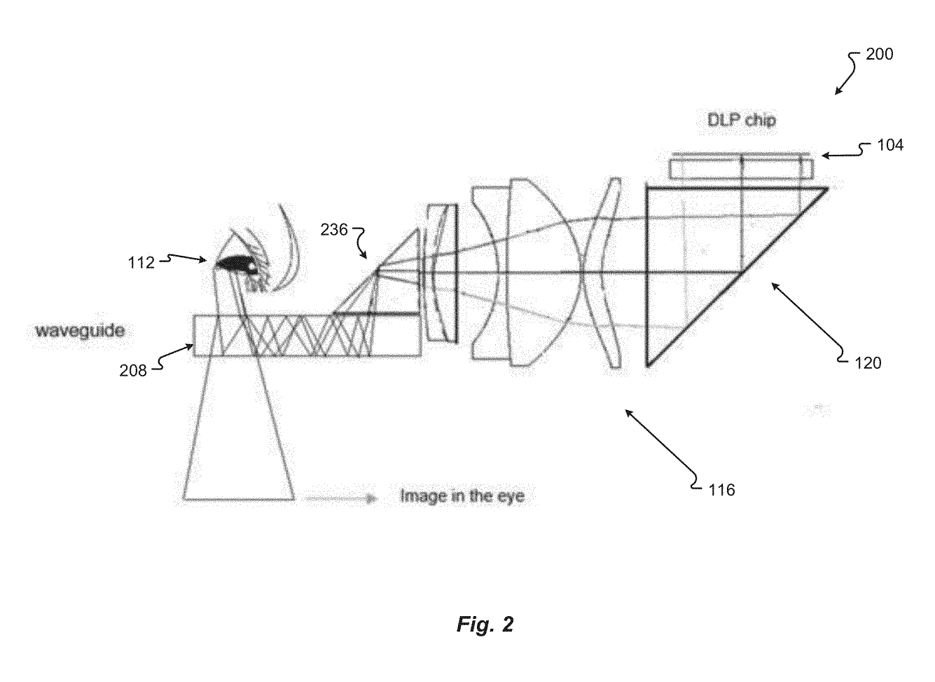

In accordance with at least one embodiment of the present disclosure, the prism/reflector may be positioned such that entry and exit surfaces of the waveguide are the same. That is, as depicted in FIG. 2, a near eye system 200 includes a prism/reflector 236 that may be located at a surface of the waveguide 208 such that the prism/reflector 236 couples optical energy to a surface of the waveguide 208 that is coplanar with a surface in which optical energy exits the waveguide 208 in a direction toward an eye 112 of a user. In such a configuration, eye relief, or the distance between the eye 112 and the waveguide 208 may be increased. Accordingly, users wearing corrective lenses may benefit from such a configuration.

More specifically, users wearing nearsighted corrective lenses may benefit from such a configuration.

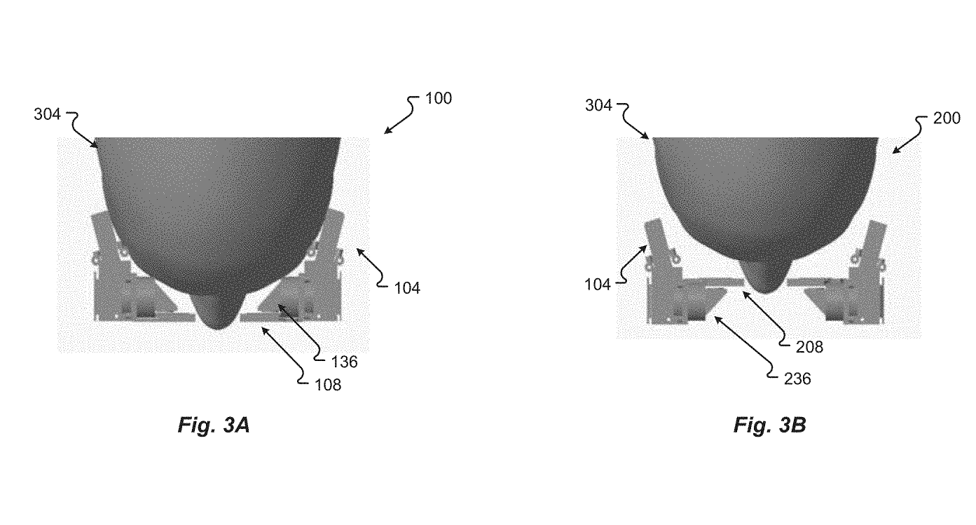

FIG. 3A depicts a perspective view of the near eye system of FIG. 1 in accordance with at least one embodiment of the present disclosure. That is, as depicted in FIG. 3A, the prism/reflector 136 couples optical energy from the DLP light engine 104 to a waveguide 108 at a surface of the waveguide 108 that is opposite to a surface of the waveguide 108 in which light exits in a direction toward an eye of a user 304.

FIG. 3B depicts a perspective view of the near eye system of FIG. 2 in accordance with at least one embodiment of the present disclosure. That is, as depicted in FIG. 3B, the prism/reflector 236 couples optical energy from the DLP light engine 104 to a waveguide 208 at a surface of the waveguide 208 that is coplanar to a surface of the waveguide 208 in which light exits in a direction toward an eye of a user, providing additional eye relief between the waveguide 208 and the eye and/or face of the user 3-4. In addition, the embodiment of FIG. 3B provides more space so that the user 308 may wear eye glasses.

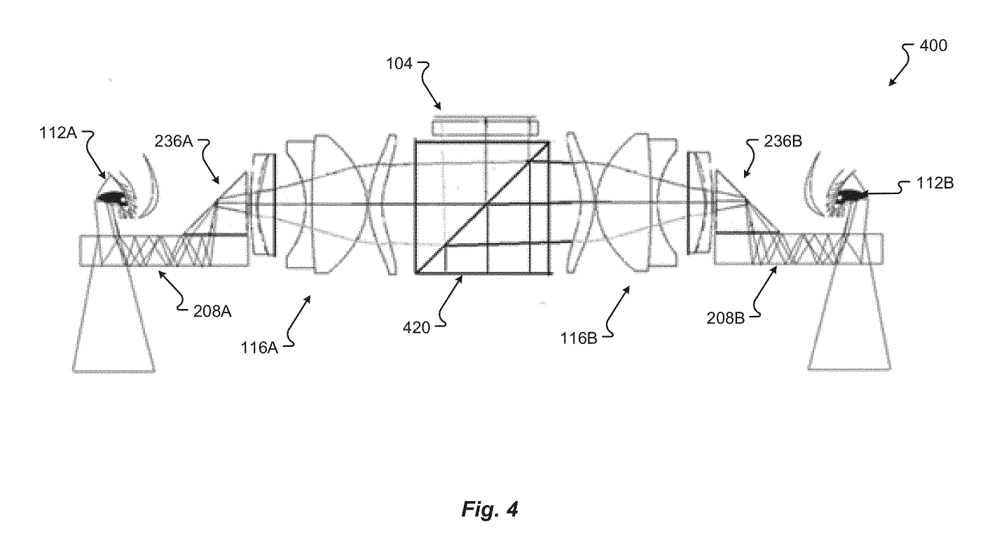

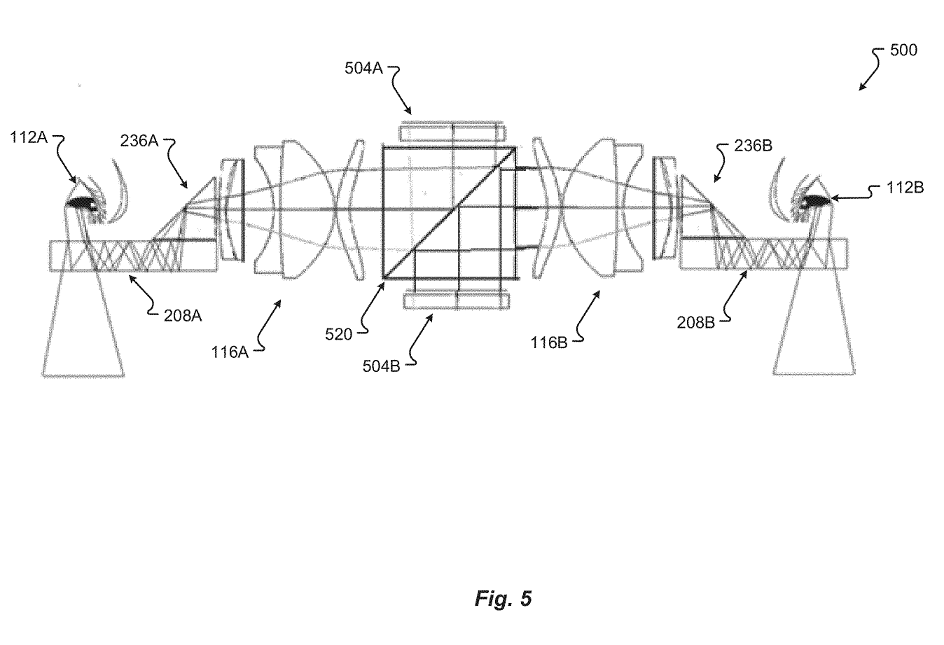

FIG. 4 depicts a third diagram of a near eye system in accordance with embodiments of the present disclosure. More specifically, FIG. 4 depicts a binocular near eye system 400 configured to provide an image to two eyes, 112A and 112B, of a user. For example, the binocular near eye system 400 may provide a three-dimensional image to the user 304. More specifically, a single DLP light engine 104 provides optical energy to the prism/reflector 420, where a portion of the optical energy may be reflected toward the lens assembly 116A while another portion of the optical energy may be transmitted through a part of the prism/reflector 420 and then reflected toward the lens assembly 116B. Although depicted as having a prism/reflector 236 at a same surface as which optical energy exits the waveguide 208, it should be appreciated that the prism/reflector 236 may be located at a surface opposite to the surface of the waveguide 208 in which optical energy exits the waveguide 208. Advantages of the near eye system 400 include decreased total power consumption and less generated heat when compared to FIGS. 3A, 3B, and 5 because only a single DLP light engine 104 is used.

In one embodiment the near eye system of FIG. 4 has the digital light processor and/or a first heatsink of the digital light processor located one a side (e.g., in the middle of the near eye system of FIG. 4) that faces away from the user. This allows heat to be dissipated away from the user.

FIG. 5 depicts a fourth diagram of a near eye system in accordance with embodiments of the present disclosure. More specifically, FIG. 5 depicts a near eye system 500 configured to provide an image to two eyes, 112A and 112B, of a user. More specifically, DLP light engines 504A and 504B are provided such that each DLP light engine 504A and 504B provides optical energy to a respective prism/reflector 520, where optical energy received from a respective DLP light engine 504 is reflected toward a respective lens assembly 116A or 116B. Thus, each eye 112A and 112B of the user receives optical energy from a respective DLP light engine 504A/504B. Although depicted as having a prism/reflector 236A/236B at a same surface as which optical energy exits the waveguide 208A/208B, it should be appreciated that the prism/reflector 236A/236B may be located at a surface opposite to the surface of the waveguide in which optical energy exits the waveguide 208A/208B. Advantages of the near eye system 500 include using two DLP light engines 504A/504B coupled to a single prism 520. In a three-dimensional augmented system for example, the images provided to each eye 112A/112B of a user should be different; accordingly, the use of two DLP light engines 504A/504B accomplishes this goal, as separate images from each DLP light engine may be provided to a respective eye of the user.

In one embodiment, a heatsink for both the DLP light engines 504A and 504B is located on a surface that faces away from the user. For example, the heatsink may be located in the middle of the near eye system facing away from the user.

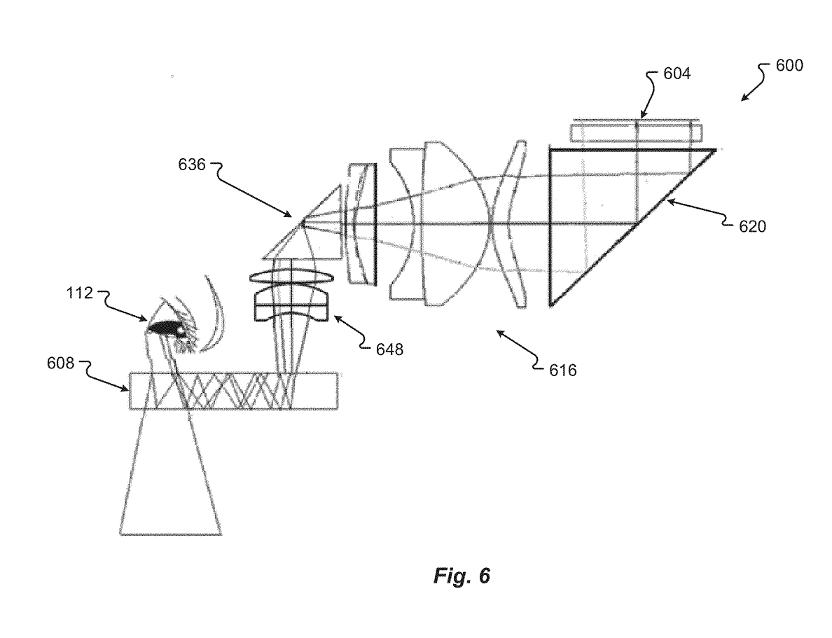

FIG. 6 depicts a fifth diagram of a near eye system 600 in accordance with embodiments of the present disclosure. FIG. 6 is similar to FIG. 2 in that a DLP light engine 604 provides optical energy to a prism/reflector 620 which directs light through a lens assembly 616 to a prism/reflector 636 which couples the optical energy into a waveguide 608, and eventually into a user's eye 112. The DLP light engine 604 may be the same as or similar to the DLP light engine 104. The prism/reflector 620 may be the same as or similar to the prism/reflector 120. The lens assembly 616 may be the same as or similar to the lens assembly 116. The prism/reflector 636 may be the same as or similar to the prism/reflector 236. The waveguide 608 may be the same as or similar to the waveguide 208. The near eye system 600 is different from the near eye system 200 in that the near eye system 600 further includes a lens assembly 648. The lens assembly 648 provides a means to adjust a focus of the optical energy reflected by the prism/reflector 636. The lens assembly 648 may comprise one or more lenses. In some embodiments, the lens assembly 648 may allow a user that normally wears corrective lenses to avoid having to do so as the focusing of the optical energy for the user's prescriptive correction may be performed by the lens assembly 648. Thus, a potential mechanical conflict between corrective lenses, the waveguide 608, and the prism/reflector 636 can be avoided.

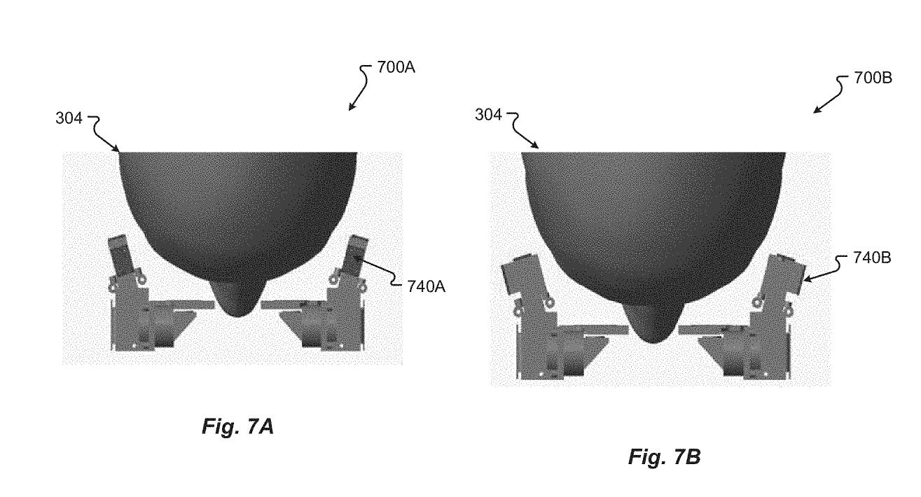

FIGS. 7A and 7B depict near eye systems 700A and near eye system 700B in accordance with embodiments of the present disclosure. The near eye system 700A may include a LED light source 740A which is located closer to the user 304. For example, the LED light source 740A (e.g., a DLP light engine 104) may be located next to the user 304 in the near eye system 700A. In contrast, the near eye system 700B may include an LED light source 740B e.g., a DLP light engine 104) which is located farther away from the user 304; thus, an increased temperature from the LED light source 740A can be avoided utilizing the configuration in near eye system 700B. In addition, a heatsink for the LED light source 740A/740B may be used to move heat further from the user 304.

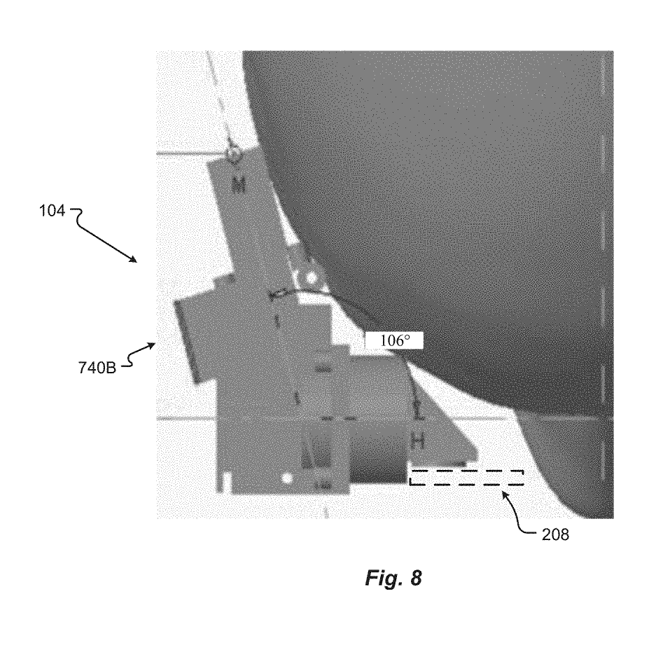

FIG. 8 depicts an angle between the DLP light engine 204, including an LED light source 740B and the waveguide 208 that is greater than or equal to 106 degrees, which again improves a user experience for a user utilizing a near eye system. If the angle becomes less than 106 degrees, the light that is projected to the user 304 may be less bright or distorted because the light will not be projected into the waveguide 120/620 correctly.

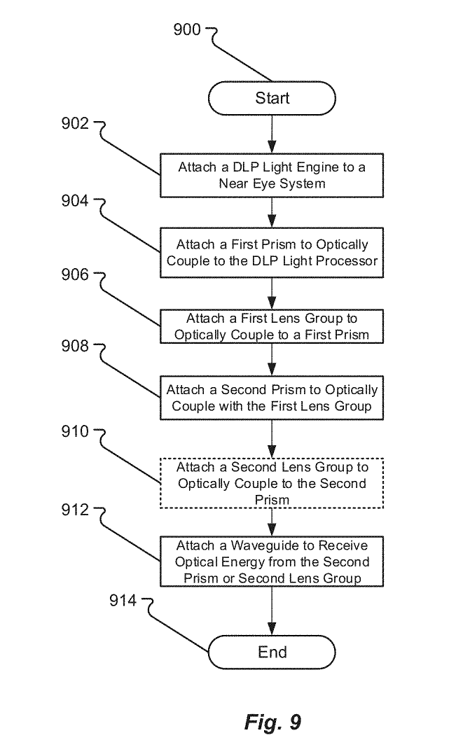

FIG. 9 is a flow diagram of a method of assembling a near eye system (100/200/600) in accordance with embodiments of the present disclosure. FIG. 9 is a flow diagram for assembling the near eye systems (100/200/600) described in FIGS. 1, 2, and 6. The process starts in step 900. The DLP light engine (104/604) is attached to the near eye system 100/200/600) in step 902. A first prism (120/620) is attached that is optically coupled to the DLP light engine (104/604) in step 904. A first lens assembly (116/616) is attached to optically couple to the first prism (120/620) in step 906. A second prism (136/236/636) is attached to optically couple with the first lens assembly (116/616) in step 908. A second lens assembly 658 is attached to optically couple to the second prism (136/236/636) in step 910. Step 910 may be optionally implemented in any of FIGS. 1, 2, and 6. A waveguide (108/208/608) is attached to receive optical energy from the second prism (136/236/636) or if step 910 is implemented to received optical energy from the second lens assembly 658 in step 912. The process then ends in step 914.

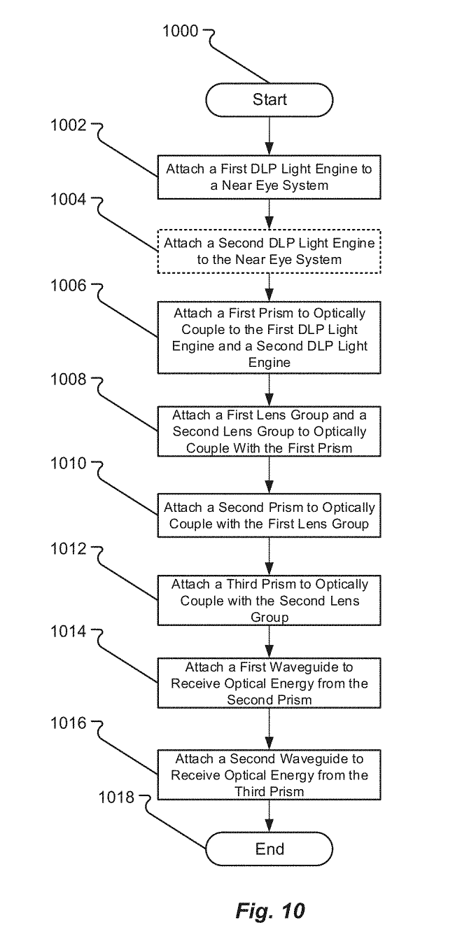

FIG. 10 is a flow diagram of a method of assembling a near eye system (400/500) in accordance with embodiments of the present disclosure. FIG. 10 is a flow diagram for assembling the near eye systems (400/500) described in FIGS. 4 and 5. The process starts in step 1000. A first DLP light engine (104/504A) is attached to a near eye system (400/500) in step 1002. A second DLP light engine 504B is attached to the near eye system 500 (FIG. 4 only has a single DLP light engine 104) in step 1004 in step 1004. A first prism (420/520) is attached to optically couple to the first DLP light engine (104/504A) and the second DLP light engine 504B in step 1006. A first lens assembly 116A and a second lens assembly 116B are attached to optically couple with the first prism (420/520) in step 1008. A second prism 236A is attached to optically couple with the first lens assembly 116A in step 1010. A third prism 236B is attached to optically couple with the second lens assembly 116B in step 1012. A first waveguide 208A is attached to receive optical energy from the second prism 236A in step 1014. A second waveguide 208B is attached to receive optical energy from a third prism 236B in step 1016. The process then ends in step 1018.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

A “prism” is a transparent optical element with flat, polished surfaces that refract light. At least two of the flat surfaces have an angle between them. The exact angles between the surfaces depend on the application. The traditional geometrical shape is that of a triangular prism with a triangular base and rectangular sides but prisms can have other geometric or nongeometric shapes. Prisms can be made from any material that is transparent to the wavelengths for which they are designed. Typical materials include glass, plastic and fluorite. The degree of bending of the light's path depends on the angle that the incident beam of light makes with the prism surface and on the ratio between the refractive indices of the two media (Snell's law). The prism can be either (a) a dispersive prism that breaks up light into its constituent spectral colors because the refractive index depends on frequency; the white light entering the prism is a mixture of different frequencies, each of which gets bent slightly differently; (b) a reflective prism that reflects light, in order to flip, invert, rotate, deviate or displace the light beam; (c) a beam-splitting prism that splits an incident light beam into two or more beams; (d) a polarizing prism that splits a beam of light into components of varying polarization; or (d) a defecting (or wedge) prism that deflects a beam of light by a fixed angle.

“Optical coupling” refers to any method of interconnecting two optical devices or elements to transfer an optical signal or light beam from one of the optical devices or elements to another optical device or element.

An “optical waveguide” is typically a spatially inhomogeneous structure for guiding light, i.e. for restricting the spatial region in which light can propagate. Usually, an optical waveguide contains a region of increased refractive index, compared with the surrounding medium (called cladding). However, guidance is also possible, e.g., by the use of reflections, e.g. at metallic interfaces. Some waveguides also involve plasmonic effects at metals. Many waveguides exhibit two-dimensional guidance, thus restricting the extension of guided light in two dimensions and permitting propagation essentially only in one dimension. An example is a channel waveguide. The most important type of two-dimensional waveguide is an optical fiber. Waveguides can also be one-dimensional waveguides, specifically planar waveguides.

The systems of this disclosure have been described in relation to the coupling of optical energy provided from a DLP light engine to a waveguide. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description.

Embodiments of the present disclosure include a near eye system, including a digital light processor, a first prism optically coupled to the digital light processor, a lens assembly optically coupled to the first prism, a second prism optically coupled to the lens assembly, and a waveguide configured to direct optical energy received from the second prism into an eye of a user. In some embodiments, an optical system having one or two waveguides and a DLP projection engine is used to generate virtual image. In some embodiments, an optical system having one or two waveguides, and a DLP projection engine is used to generate virtual image in an augmented reality system, where the system provides a field of view that is more than 40 degrees.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

What is claimed is:

1. A first near eye system, comprising:
a digital light processor;
a first prism optically coupled to the digital light processor;
a first lens assembly optically coupled to the first prism;
a second prism optically coupled to the first lens assembly; and
a waveguide configured to direct optical energy received from the second prism into an eye of a user.

2. The first near eye system of claim 1, wherein the second prism is optically coupled with the waveguide on a same side as the eye of the user.

3. The first near eye system of claim 1, wherein the second prism is optically coupled with the waveguide on an opposite side from the eye of the user.

4. The first near eye system of claim 1, wherein the digital light processor is located on a side of the near eye system that is away from the user.

5. The first near eye system of claim 1, wherein a heatsink of the digital light processor is located on a side that is away from the user.

6. The first near eye system of claim 1, wherein the digital light processor is located at an angle that is greater than or equal to 106 degrees from the waveguide.

7. The first near eye system of claim 1, further comprising:
a second lens assembly, wherein the second lens assembly is optically coupled between the second prism and the waveguide.

8. The first near eye system of claim 1, wherein a distance between the second prism and the waveguide is less than 4 millimeters.

9. The first near eye system of claim 1 further comprising a second near eye system.

10. A near eye system, comprising:
a digital light processor;
a first lens assembly;
a second lens assembly;
a first prism optically coupled to the digital light processor, the first lens assembly, and the second lens assembly;
a second prism optically coupled to the first lens assembly;
a third prim optically coupled to the second lens assembly;
a first waveguide that directs optical energy received from the second prism into a first eye of a user; and
a second waveguide that directs optical energy received from the third prism into a second eye of the user.

11. The near eye system of claim 10, wherein the second prim is optically coupled with the first waveguide on a first same side as the first eye of the user and wherein the third prim is optically coupled with the second waveguide on a second same side as the second eye of the user.

12. The near eye system of claim 10, wherein the second prim is optically coupled with the first waveguide on a first opposite side from the first eye of the user and wherein the third prim is optically coupled with the second waveguide on a second opposite side from the second eye of the user.

13. The near eye system of claim 10, wherein the digital light processor and/or a first heatsink of the digital light processor are located on a side of the near eye system that faces is away from the user.

14. The near eye system of claim 10, wherein a first distance between the second prism and the first waveguide is less than 4 millimeters and wherein a second distance between the third prism and the second waveguide is less than 4 millimeters.

15. A near eye system, comprising:
a first prism;
a first digital light processor;
a second digital light processor, wherein the first digital light processor and the second light processor are optically coupled to the first prism;
a first lens assembly;
a second lens assembly, wherein the first prism is optically coupled to the first lens assembly and the second lens assembly;
a second prism optically coupled to the first lens assembly;
a third prim optically coupled to the second lens assembly;
a first waveguide configured to direct optical energy received from the second prism into a first eye of a user; and
a second waveguide configured to direct optical energy received from the third prism into a second eye of the user.

16. The near eye system of claim 15, wherein the first digital light processor and the second light processor are optically coupled to the first prism on opposite sides of the first prism.

17. The near eye system of claim 15, wherein the second prim is optically coupled with the first waveguide on a first same side as the first eye of the user and wherein the third prim is optically coupled with the second waveguide on a second same side as the second eye of the user.

18. The near eye system of claim 15, wherein the second prim is optically coupled with the first waveguide on a first opposite side of the first eye of the user and wherein the third prim is optically coupled with the second waveguide on a second opposite side from the second eye of the user.

19. The near eye system of claim 15, wherein a heatsink of the first digital light processor and/or the second digital light processor is located on a side of the near eye system that faces is away from the user.

20. The near eye system of claim 15, wherein a first distance between the second prism and the first waveguide is less than 4 millimeters and wherein a second distance between the third prism and the second waveguide is less than 4 millimeters.
